(19) United States
(12) Patent Application Publication
(10) Pub. No.: US 2026/0137586 A1
(43) Pub. Date: May 21, 2026

(54) FASCIA GUN AND MASSAGE HEAD FOR A FASCIA GUN

(71) Applicant: Shenzhen Faray InfoTech Co.,Ltd, Shenzhen (CN)

(72) Inventors: Wei Chen, Wenzhou (CN); Jinlong Lin, Shenzhen (CN)

(21) Appl. No.: 19/355,002

(22) Filed: Oct. 10, 2025

Related U.S. Application Data
(63) Continuation-in-part of application No. 18/950,385, filed on Nov. 18, 2024, now abandoned.

(51) Int. Cl. A61H 23/00

(52) U.S. Cl. CPC A61H 23/006; A61H 2201/0153; A61H 2201/149

(57) ABSTRACT

The present disclosure provides a fascia gun and a massage head for the fascia gun. The fascia gun comprising: a housing; a connecting rod extending outside the housing; the fascia gun configured to do reciprocating motions along a predetermined first direction, thereby massaging an object to be massaged; and the massage head. The massage head comprising a massage member and a connecting member, the connecting member comprises a first portion arranged along the first direction and a second portion arranged along a second direction intersects with the first direction; the first portion having a first maximal cross-section which is perpendicular to the first direction, the second potion having a second maximal cross-section which is perpendicular to the first direction, wherein the first maximal cross-section is smaller than the second maximal cross-section.

### RELATED APPLICATIONS

This application is a Continuation in part of application Ser. No. 18/950,385, filed on November 18, 2024.

### TECHNICAL FIELD

The present disclosure relates to the technical field of medical and health care equipment, in particular to a fascia gun and a massage head for the fascia gun.

### BACKGROUND

Sports and fitness are popular in urban life. People may feel muscle stiffness and soreness after exercises. Having a muscle relaxation session after exercise is an effective method to release muscle stiffness and/or pain. A fascia gun may be used during the relaxation session. The fascia gun can break off muscle adhesions, warm up muscles, activate cells, and ensure smooth blood flow based on its precise, high-frequency, and deep vibrations, thereby accelerating muscle recovery and reducing lactic acid.

However, for some fascia guns on the market, the massage head is directly connected to the transmission member. When users attempt to detach the massage head from the fascia gun, the users often need to apply a large force or go through complex steps, resulting in a poor user experience.

### BRIEF DESCRIPTION OF DRAWINGS

Embodiments of the present disclosure will now be described, by way of embodiment, with reference to the attached figures. The structure, operation, and advantages of the present invention will become further apparent upon consideration of the following description taken in conjunction with the accompanying figures. The figures are intended to be illustrative, and not limiting.

FIG. 1 is a perspective view of a fascia gun of an embodiment of the present disclosure, the fascia gun including a connecting member 30 and a massage member 50.

FIG. 2 is a cross-sectional view of the fascia gun shown in FIG. 1, the cross-section shown in Part A (the part in the circle) of FIG. 2 is drawn to true scale, and a proportional relationship between the connecting member 30 and the massage member 50 shown in the figure reflects the actual fitting state.

FIG. 3 is a cross-sectional view of an assembly of the connecting member 30 and the massage member 50 of the fascia gun shown in FIG. 1, drawn to true scale.

FIG. 4 is a cross-sectional view of the massage member 30 of the fascia gun shown in FIG. 1, drawn to true scale.

FIG. 5 is a cross-sectional view of the assembly of the connecting member and the massage member shown in FIG. 1, wherein (a) illustrates a cross-section of a connecting rod, (b) illustrates a cross-section of a first portion, (c) illustrates a maximal cross-section of a second portion, and (d) illustrates a cross-section of an opening of a mounting portion, all drawn to true scale.

FIG. 6 is a perspective view of the assembly of the connecting member and the massage member of the fascia gun shown in FIG. 1, drawn to true scale.

FIG. 7 is a perspective view of an assembly of the connecting member, the massage member and a connecting rod of the fascia gun shown in FIG. 1, drawn to true scale.

FIG. 8 is an amplified view of a partial A in FIG. 2, which illustrates assembly relations among the massage member, the connecting member and the connecting rod, drawn to true scale.

FIG. 9 is a cross-sectional view of the assembly of the connecting member and a connecting rod in FIG. 1 which illustrates the connecting rod inserted into the connecting member, drawn to true scale.

FIG. 10 is a schematic view of the fascia gun in FIG. 1 in a usable state, state (a) illustrates the connecting member massages a body of the user, state (b) illustrates the massage member massages the body of the user.

FIG. 11 is an exploded view of the fascia gun shown in FIG. 1.

### DETAILED DESCRIPTION

In the description that follows, numerous details are outlined to provide a thorough understanding of the present invention. It will be appreciated by those skilled in the art that variations of these specific details are possible while still achieving the results of the present invention.

Exemplary illustrative embodiments of the invention should be interpreted as example(s) and non-limiting. The relationship between various arms, where they are located, their composition(s), their operation and sometimes their sizes relative to the desired operation of the invention are significant.

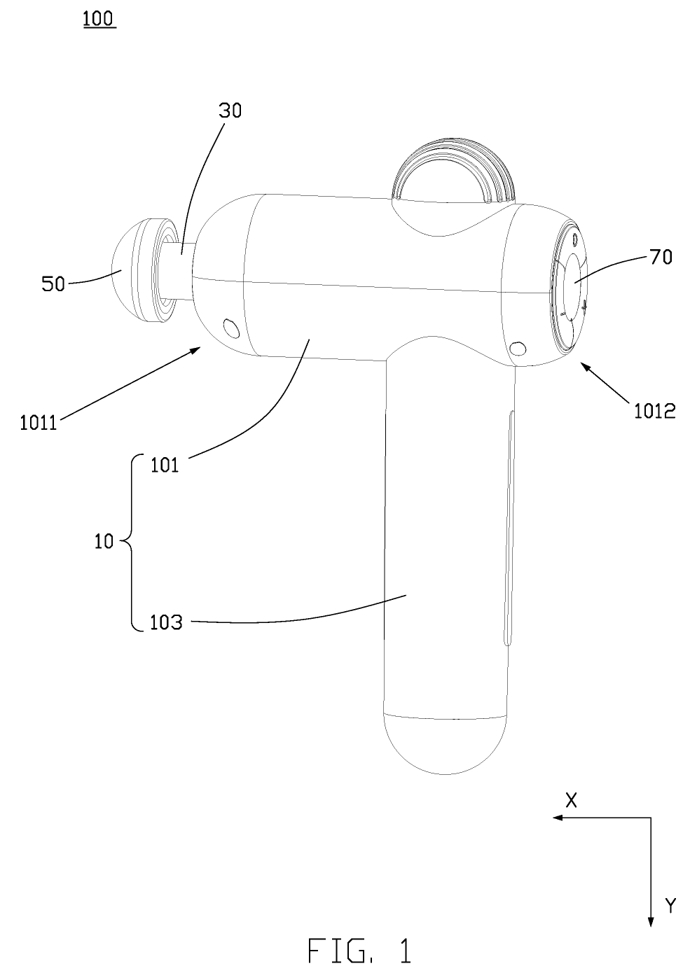

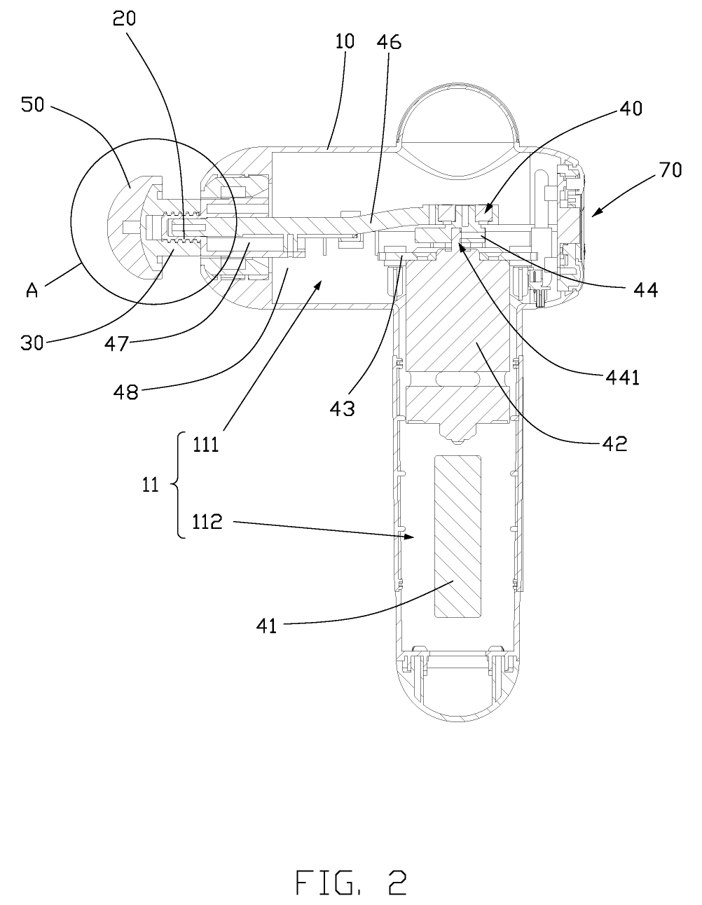

Referring to FIG. 1 and FIG. 2, a fascia gun 100 of an exemplary embodiment of the present disclosure is provided. The fascia gun 100 is capable of doing reciprocating motions along a predetermined direction to apply external forces onto an object which is being massaged. The predetermined direction is defined as a first direction X. The fascia gun 100 includes a handle portion 103 configured for being gripped by a user and a vibration output portion 101 configured for generating outputting vibrations. The vibration output portion 101 is capable of generating a force that enables the reciprocating motion in the first direction X. The handle portion 103 is arranged to be substantially perpendicular to this first direction X. In some exemplary embodiments of the present disclosure, the handle portion 103 is provided with a certain angle to the first direction X. The fascia gun 100 further includes a housing 10, a vibration connecting rod 20, a transmission member 40, a control member 70, and a massage head 200.

The housing 10 defines a cavity 11 extending along the first direction X. The transmission member 40 is partly accommodated in the cavity 11, with a portion of the transmission member 40 protruding out of the housing 10. One end of the connecting member 30 is connected to the vibration connecting rod 20, while a massage member 50 is connected to another end of the connecting member 30. The control member 70 is configured to drive the transmission member 40 to do the reciprocating motions along the first direction X, such as in a horizontal direction. The massage member 50 is driven by the connecting member 30 to achieve a massage effect.

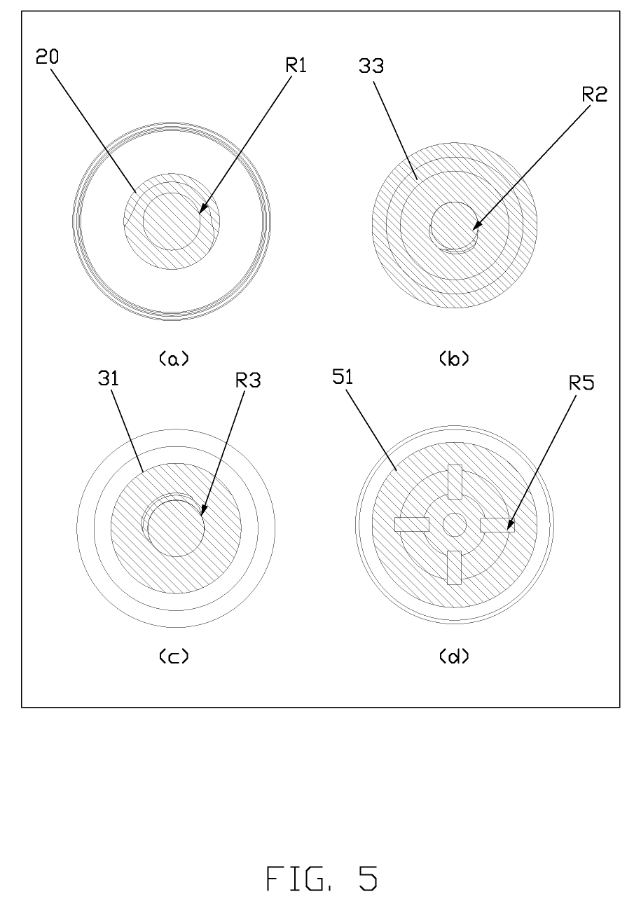

The housing 10 includes an output port 10a. at which an output muzzle of the fascia gun 100 is attached. The housing 10 has a hollow shape for accommodating internal functional components of the fascia gun 100 therein. The housing 10 defines a first cavity 111 for receiving the vibration output portion 101 and a second cavity 112 for receiving the handle portion 103. The first cavity 111 is air communicated with the second cavity 112. The first cavity 111 can be for example perpendicular to the second cavity 112. The transmission member 40 is also received in the first cavity 111. The transmission member 40 includes a transmission rod 46 which is connected to the vibration connecting rod 20. A portion of the transmission rod 46 protrudes out of the housing 10 from the output port 10a, with the connecting member 30 being attached to the portion of the transmission rod 46. The second cavity 112 accommodates a power source 41. In some exemplary embodiments of the present disclosure, the vibration connecting rod 20 is rod-shaped and has a first cross-section R1 (e.g., an area denoted by shadow lines in FIG. 5) on a plane perpendicular to the first direction X. A thread 201 is formed on an end surface of the vibration connecting rod 20 outside the housing 10. Correspondingly, a reverse thread 3111 matching the thread 201 is formed on the connecting member 30. The end of the vibration connecting rod 20 is screwed into the connecting member 30 by rotating along the threads. and tightly fits with the connecting member 30. The connecting member 30 is undetachable from the vibration connecting rod 20 when the fascia gun 100 is in use. In some other embodiments, the vibration connecting rod 20 and the transmission rod 46 are integrally-formed. In some other embodiments, the vibration connecting rod 20 directly inserts into the connecting member 30 without thread 201.

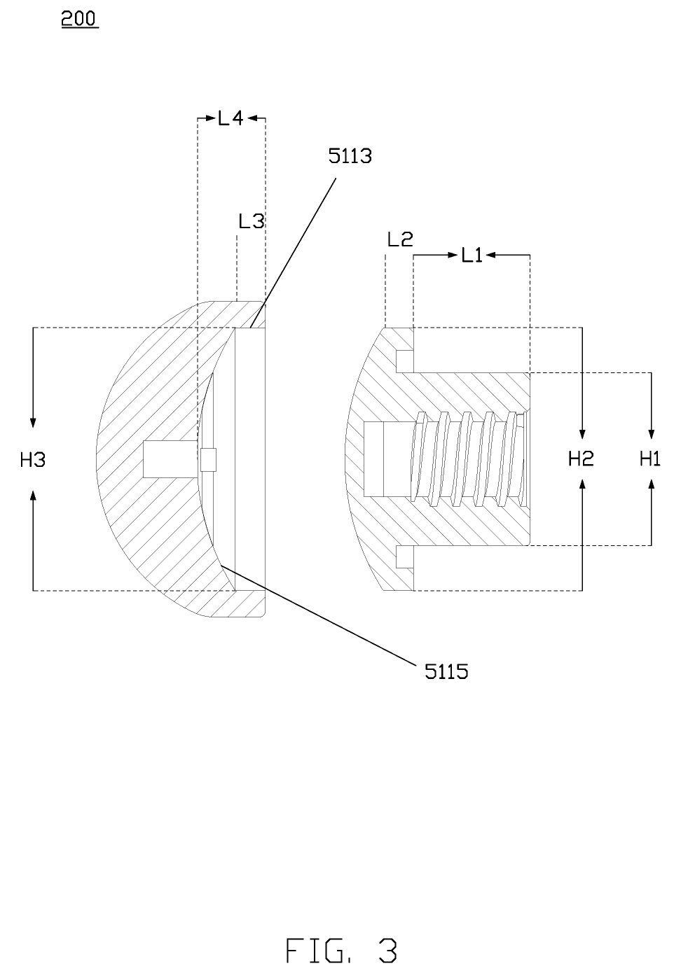

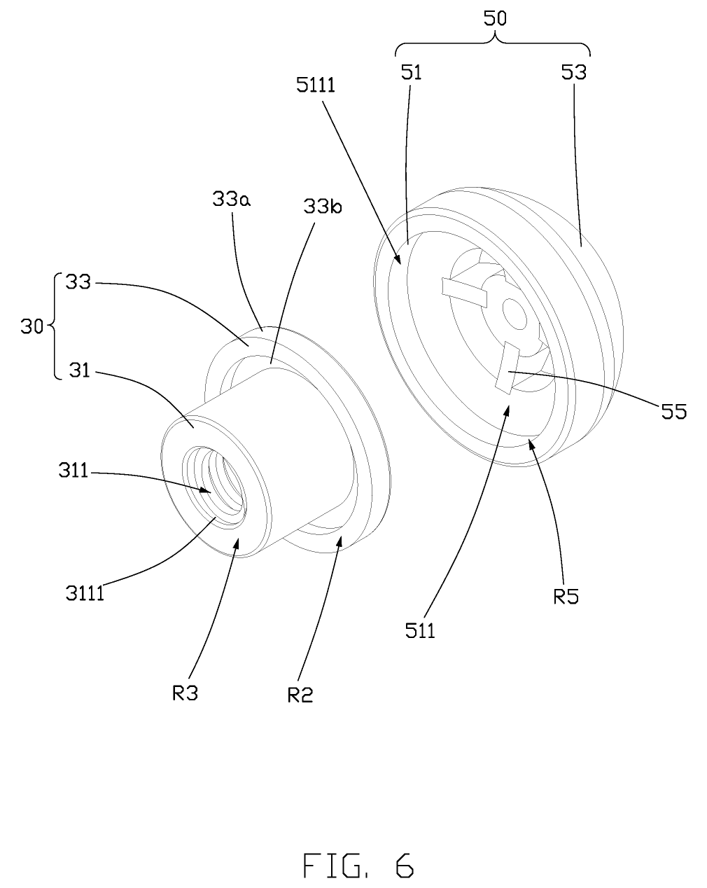

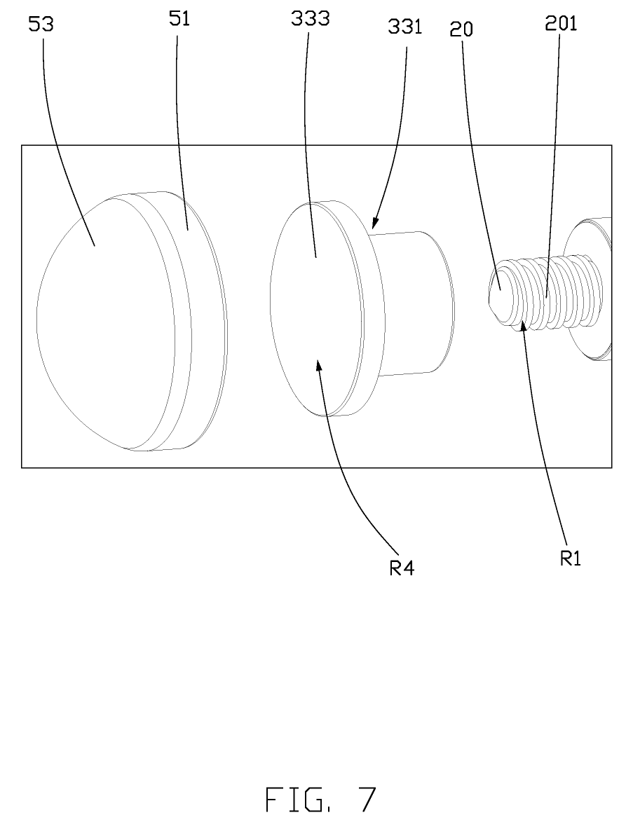

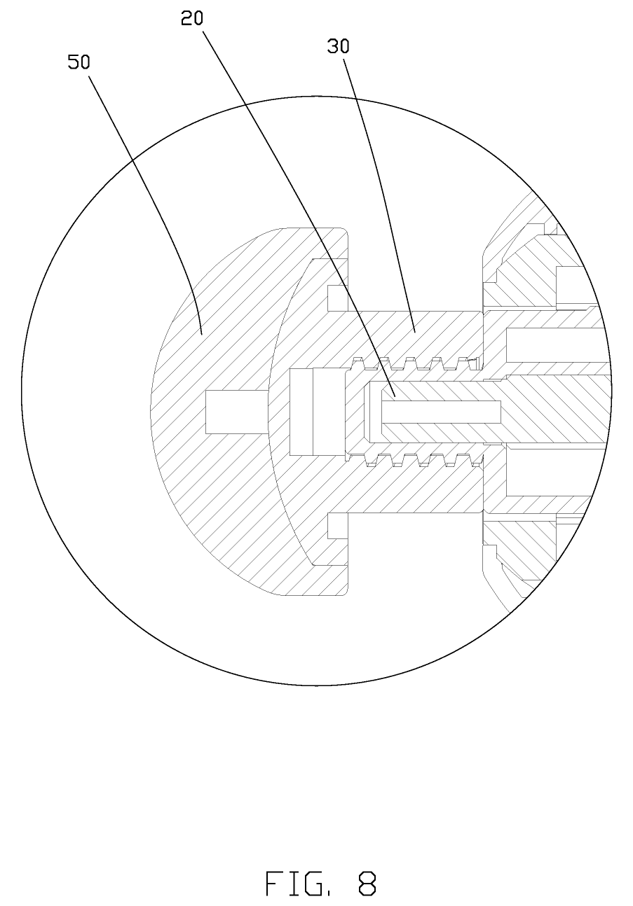

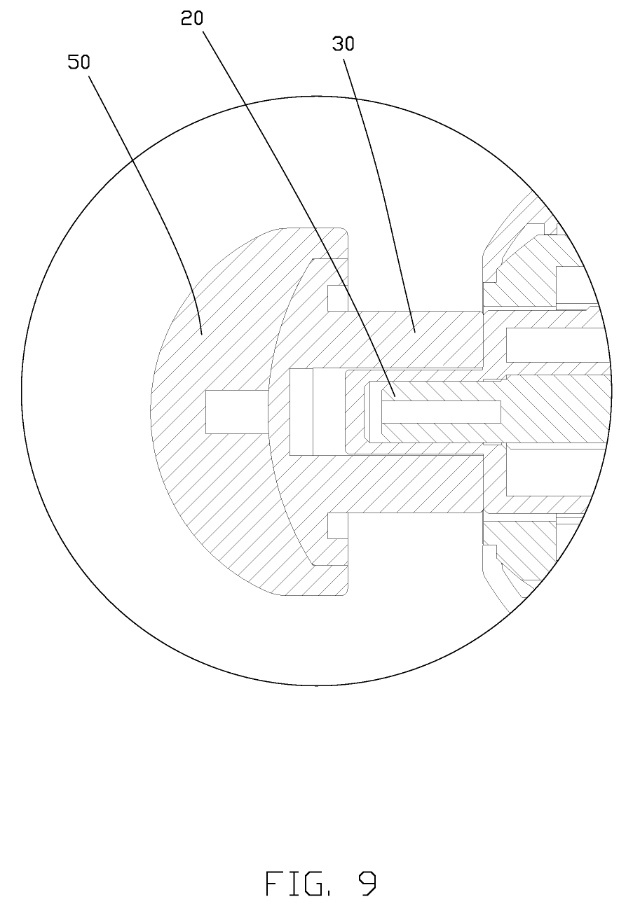

Referring to FIG. 3 to FIG. 10, in some exemplary embodiments of the present disclosure, the connecting member 30 includes a first portion 31 configured to connect with the transmission member 40 and a second portion 33 configured to connect with the massage member 50. The second portion 33 is coupled to an end of the first portion 31. The second portion 33 includes a sidewall 33a surrounding the end of the first portion 31 and an end wall 33b inwardly extending from the sidewall 33a and connected to the end of the first portion 31. The sidewall 33a is protruding relative to the end wall 33b. The end of the first portion 31 may be coaxial with the second portion 33 and spaced away the sidewall 33a of the second portion 33. Furthermore, the sidewall 33a of the second portion 33 includes a first surface 331 at an end of the sidewall 33a and towards the first portion 21, and the end wall 33b of the second portion 33 includes a contacting surface 333 configured to extend into the massage member 50 for connecting with the massage member 50. In some exemplary embodiments of the present disclosure, the contacting surface 333 is a curved surface protruding away from the first surface 331.

In some exemplary embodiments of the present disclosure, the connecting member 30 is an inverted T-shaped. The first portion 31 shaped as a cylindrical structure corresponds to a vertical part of the letter “T” and is arranged along the first direction X. The first portion 31 defines a connecting hole 311 at another end. The reverse thread 3111 is formed at an inner wall of the connecting hole 311. The second portion 33 shaped as a round pancake structure corresponds to a horizontal part of the letter “T” and is arranged along a second direction Y which is perpendicular to the first direction X. Referring to FIG. 3 (drawn to true scale), A second diameter H2 of the second portion 33 at the second direction Y, is at least 1.3-1.5 times longer than a first diameter H1 of the first portion 31 at the second direction Y. Based on experimental results, when the ratio of the second diameter H2 to the first diameter H1 is less than 1.3, it results in an uncoordinated overall appearance of the fascia gun 100. When the ratio of the second diameter H2 to the first diameter H1 is greater than 1.5, the probability of the massage member 50 falling off also increases. Referring to (b) and (c) of FIG. 5 (drawn to true scale), a maximum size of a second cross-section R2 of the second portion 33 at a plane perpendicular to the first direction X, is larger than a maximum size of a third cross-section R3 of the first portion 31 at a plane perpendicular to the first direction X. The maximum size can for example get from an orthographic projection thereof on the plane perpendicular to the first direction X. The first portion 31 is tightly fitted with the vibration connecting rod 20. The connecting member 30 through the second portion 33, provides with a mediated cross-section R4 that is larger than the third cross-section R3 required for the tight fitting between the first portion 31 and the massage member 50. The mediated cross-section R4 is configured for the connection and adaptation between the connecting member 30 and the massage member 50.

The massage member 50 is adapted to the connecting member 30 and used to contact an object which is to be massaged, such as shoulders and legs. The massage member 50 includes a mounting portion 51 and a massage portion 53. The mounting portion 51 is configured for connecting with the connecting member 30. The mounting portion 51 has a recessed area 511 which is inwardly depressed from an end of the massage member 50. The recessed area 511 has a connecting opening 5111 with a fourth area size R5 configured to allow the contacting surface 333 of the second portion 33 to fully fit into the recessed area 511. In some exemplary embodiment of the present disclosure, the recessed area 511 is arranged as a hemispherical shape, and the connecting opening 5111 is correspondingly shaped as a circle. The recessed area 511 is defined by an arc-shaped concave surface 5115 opposite to the contacting surface 333 of the second portion 33 and a circular base 5113 formed by extending from the periphery of the arc-shaped concave surface 5115 to the connecting opening 5111 of the massage member 50 abutting against the connecting member 30. Referring to FIG. 3 (drawn to true scale), A fourth length L4 from the deepest point of the recessed area 511 to the connecting opening 5111 is less than a half of a third diameter H3 of the connecting opening 5111. A difference value between a third diameter H3 of the connecting opening 5111 of the recessed area 511 at the second direction Y and the second diameter H2 of the second portion 33 at the second direction Y is about 0.8~1.2 millimeters. The circular base 5113 has a third length L3 at the first direction X, which is not less than a second length L2 of the second portion 33 in the first direction X. The second length L2 is not greater than half of a first length L1 of the first portion 31 in the first direction X, thereby enabling the massage member 50 to be mounted onto the connecting member 30.

Furthermore, the massage member 50 is sleeved on the second portion 33 of the connecting member 30. At this time, the circular base 5113 completely covers and/or aligns with the sidewall 33a of the second portion 33. Because the second portion 33 has a bigger cross-section than the first portion 31, a small force is needed to engage the massage member 50 with the connecting member 30. The massage member 50 and the connecting member 30 are tightly connected mainly through sufficient friction generated between the contacting surfaces of the massage member 50 and the connecting member 30. The friction enables the massage member 50 to be less susceptible to detachment under applied force, thus effectively enhancing the user experience.

The massage member 50 is made of a material which has a hardness lower than that of the material of the connecting member 30. An engagement relationship between the connecting member 30 and the massage member 50 is established via the cooperation between the arc-shaped concave surface 5115 and the contacting surface 333 of the second portion 33 without additional engagement elements.

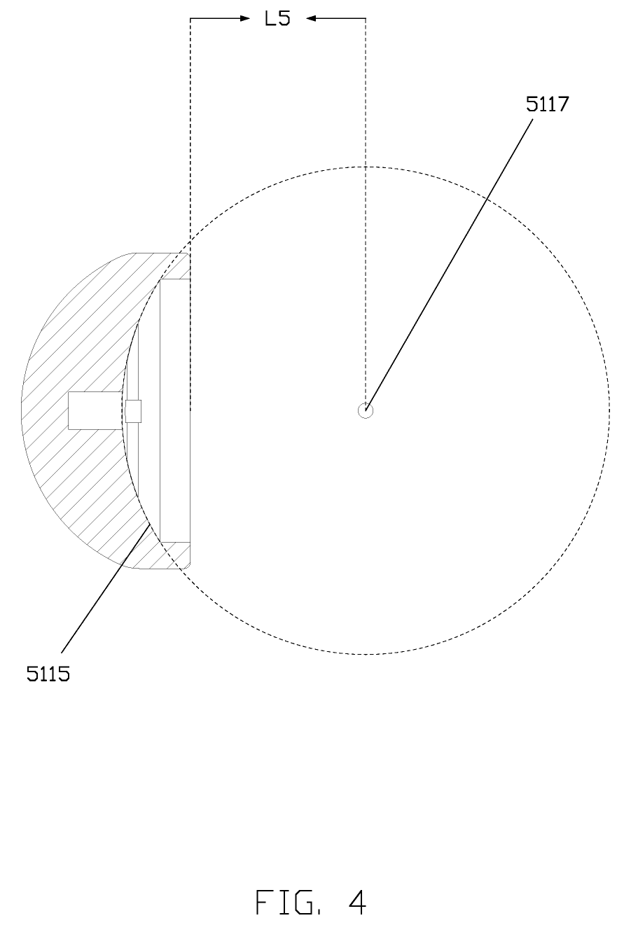

Referring to FIG. 4, a center point 5117 of the arc-shaped concave surface 5115 is located outside the recessed area. A fifth length L5 from the connecting opening 5111 to the center point 5117 is greater than the forth length L4.

The shape of the massage portion 53 may be regular or irregular, specifically may be any one of circle, semicircle, ellipse, square, rectangle, triangle, polygon, D-shape, C-shaped, kidney-shaped, heart-shaped, gourd-shaped, briolette, etc., or may be a combination of at least two of them. It can be understood that the shape of the massage portion 53 may be set according to needs, which is not limited to the embodiments.

A plurality of reinforcing ribs 55 are formed in the massage member for preventing the massage member from deformation. The plurality of reinforcing ribs are arranged along a circumference of the recess, with each rib extending radially.

Furthermore, the connecting member 30 is made of a first material. As the connecting member 30 needs to be threadedly connected to the transmission member 40, the first material is a hard material that does not deform during rotation, ensuring smooth rotation. The first material may be ABS, PA or POM. The massage member 50 is made of a second material. Since the massage member 50 directly contacts a body of the user, the second material is preferably a soft material, that is, the hardness of the second material is lower than the first material. The second material may be Silicone, PVC, PU or PP.

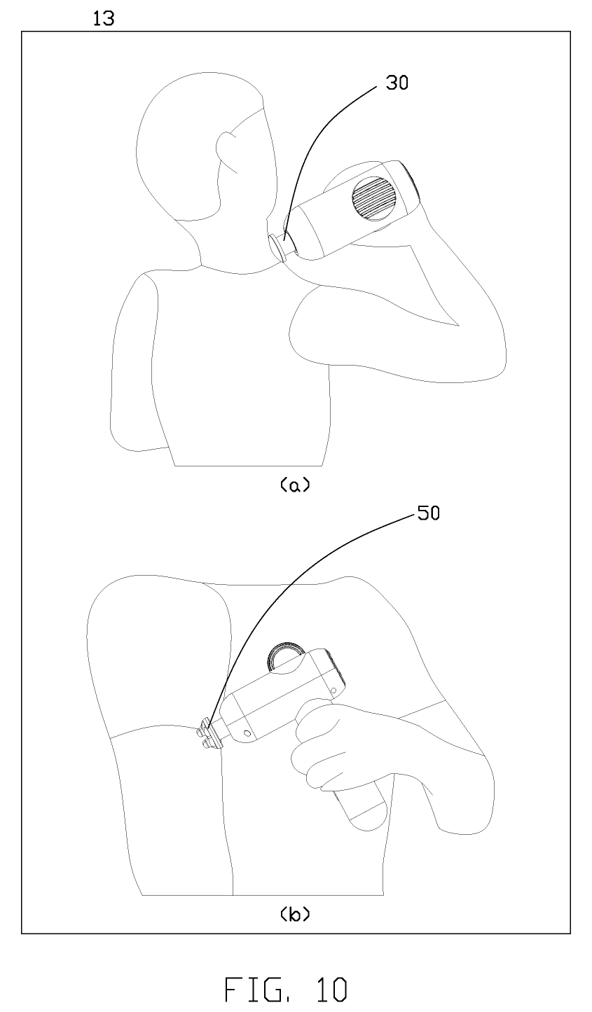

Referring to FIG. 10, the massage member 50 is detachable from the connecting member 30. In this embodiment, the contacting surface 333 of the connecting member 30 is configured to directly contact a massage area of the body when the massage member 50 is detached from the connecting member 30. The massage portion 53 has a massage surface made of soft material, which is sleeved onto the connecting member 30. The connecting member 30 is primarily used for massaging large muscle groups, such as back and leg muscles. The massage portion 53 is primarily used for smaller, more sensitive muscle groups, such as abdominal muscles and palm muscles. Users can select them according to their needs.

Further, the connecting member 30 is threadedly connected to the transmission member 40. The threaded connection ensures that the connecting member 30 will not easily fall off from the transmission member 40 due to impact forces from the transmission member 40 during massage, thereby providing a more stable connection.

Referring to FIG. 2 and FIG. 10, the transmission member 40 includes a power source 41, a motor 42, a positioning plate 43, an eccentric wheel 44, a bearing 45, a transmission bar 46, a connecting sleeve 47, a limiting sleeve 48 and a ball bearing 49, which are sequentially connected. The power source 41 is electrically connected to the motor 42 and configured to provide electrical power to the motor 42. The eccentric wheel 44 is configured to connect to the motor 42, and the bearing 45 and transmission bar 46 are coaxially connected to the eccentric wheel 44. The connecting rod 47 extends outside the housing 10 and is connected to the connecting member 30. The portion of the connecting rod 47 that has threads protrudes outside the housing 10. The limiting sleeve 48 is sleeved over the connecting rod 47.

In some exemplary embodiments of the present disclosure, there is a connecting member 30 arranged between the massage member 50 and the connecting rod 47. In order to make installation more labor-saving, the mounting hole between the massage member 50 and the connecting member 30 is designed as a wider hole compared to the prior art, and the connecting rod 47 and the connecting member 30 are connected via a threaded connection. Compared with the prior embodiment that needs to design a concave mounting hole in the massage member 50 or the connecting member 30 and requires more force to insert the connecting rod 47 into the concave mounting hole, the connection method of this embodiment not only ensures a firm connection but also makes assembly more labor-saving. It can also shorten the length of the connection area among the massage head, the adapter, and the connecting rod, making it more suitable for the requirements of small-sized fascia guns.

The motor 42 comprises a main body 421, a boss 422 and a rotating shaft 423. The top of the main body 421 forms the boss 422, and the rotating shaft 423 is arranged inside the main body 421 and protrudes through the boss 422. The four sides of the positioning plate 43 are engaged with the inner wall of the housing 10, thereby fixing the position of the transmission member 40. A positioning hole 431 is arranged in the middle of the positioning plate 43, and the boss 422 is inserted into the positioning hole 431, such that the motor 42 is mounted on the positioning plate 43. The thickness of the boss 422 is same as the positioning hole 431, that is, the top of the boss 422 is substantially flush against the top of the positioning plate 43.

The middle of the bottom of the eccentric wheel 44 is provided with a first through hole 441, and an eccentric bar 442 extends from the top of the eccentric wheel 44. The eccentric bar 442 is misaligned with the first through hole 441, so that the eccentric rod 442 is eccentric with respect to the axis 443 of the first through hole 441. The rotating shaft 423 is inserted into the first through hole 441, such that the eccentric wheel 44 is connected to the motor 42. The positioning plate 43 is installed between the motor 42 and the eccentric wheel 44. The eccentric bar 442 is inserted into the inner ring of the bearing 45, and the outer ring of the bearing 45 is embedded in the second through hole 461 of the transmission bar 46, thereby the bearing 45 and transmission bar 46 are coaxially connected to the eccentric wheel 44.

The limiting sleeve 48 is sleeved on the connecting rod 47 and clamped inside the housing 10. The housing 10 limits the limiting sleeve 48. The inner wall of the limiting sleeve 48 is boned to the connecting rod 47, so that the limiting sleeve 48 limits the connecting rod 47, enabling the transmission member 40 to move linearly, that is, the limiting sleeve 48 limits the connecting rod 47 to move in the vertical direction of the housing 10. The position of the limiting sleeve 48 is fixed with respect to the housing 10, and the connecting rod 47 can move back and forth with respect to the limiting sleeve 48.

The ball bearing 49 is installed between the limiting sleeve 48 and the connecting sleeve 47, thereby reducing the friction between the limiting sleeve 48 and the connecting sleeve 47 and significantly lowering the operational noise of the product.

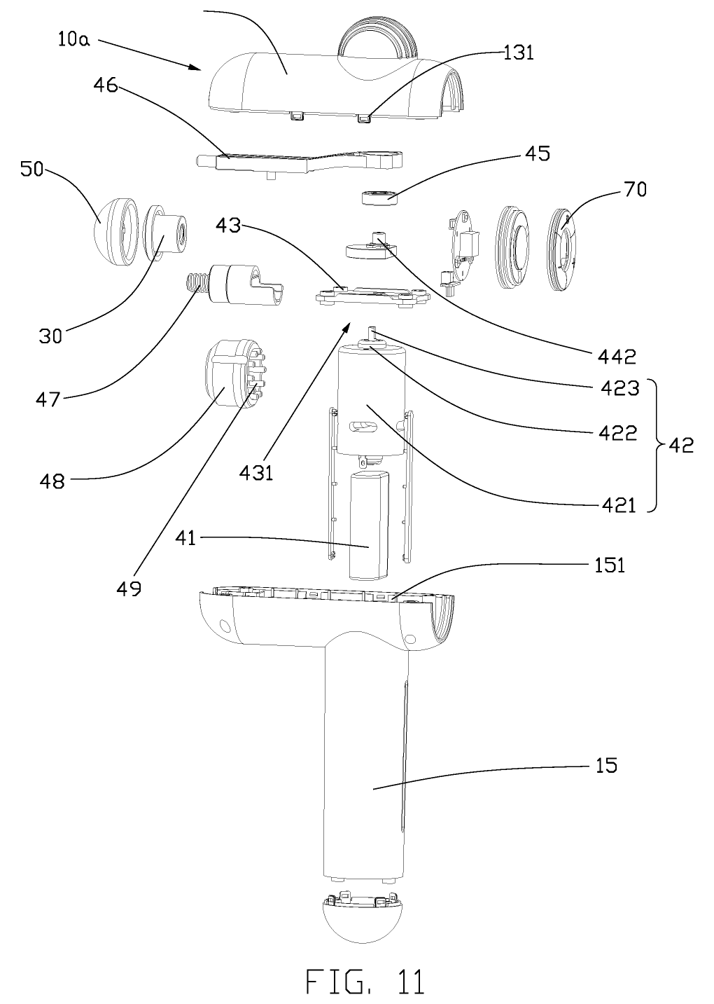

Referring to FIG. 2 and FIG. 11, the housing 10 includes an upper housing 13 and a lower housing 15. The lower housing 15 is T-shaped and includes a portion arranged transversely and a portion arranged vertically. The side of the upper housing 13 close to the lower housing 15 is provided with a plurality of buckles 131. The side of the lower housing 15 close to the upper housing 13 is provided with a plurality of grooves 151. The upper housing 13 and the lower housing 15 are connected by the buckles 131 and the grooves 151.

Both the front end and back end of the upper housing 13 and the lower housing 15 form U-shaped grooves. When the upper housing 13 and the lower housing 15 are connected, the vibration output portion 101 forms a first opening 1011 and a second opening 1012 opposite to each other. The transmission member 40 extends from a position close to the second opening 1012 towards a position close to the first opening 1011 and protrudes outside the housing 10 through the first opening 1011. A control member 70 is provided at the second opening 1012 and is configured to control the movement frequency of the transmission member 40. It can be understood that the fascia gun 100 can also be controlled by remote control or wireless control.

The contents not described in detail in this specification are known to those skilled in the art.

In the description of the present disclosure, it should be understood that terms such as "center", "longitudinal", "lateral", "length", "width", "thickness", "top", "bottom", "front", "rear", "left", "right", "vertical", "horizontal", "upper", "lower", "inner", "outer", "clockwise", "counterclockwise", etc., indicate the orientation or positional relationship based on the orientation or positional relationship shown in the drawings. These terms are used for descriptive purposes and are not to be construed as limiting, indicating, or implying any particular orientation, construction or operation for the devices or arms referred to. Therefore, it should be understood that the terms "first," "second," etc., are used for descriptive purposes only and do not imply or suggest any relative importance or indicate the quantity of technical features indicated.

The foregoing illustrates and describes the basic principles and main features of the present disclosure and its advantages. Those skilled in the art should understand that the present disclosure is not limited to the embodiments described above. The embodiments and descriptions in the specification are intended only to illustrate the principles of the present disclosure. Within the scope and spirit of the present disclosure, various modifications and improvements can be made which fall within the scope of protection defined by the appended claims and their equivalents.

What is claimed is:

1. A fascia gun comprising:
a housing defining an opening;
a connecting rod receivable in the housing and partly protruding out of the housing through the opening, and movable along a first direction.
a massage head coupled to the connecting rod at a side of the housing, the massage head comprising:
a massage member configured to contact to an object to be massaged, and the massage member comprising a massage contacting surface configured for contacting the object to be massaged, and an arc-shaped concave surface arranged opposite the massage contacting surface and curving inward toward the massage contacting surface; and
a connecting member connectable to the massage member and the connecting rod, the connecting member comprising a first portion detachably connected to the connecting rod and a second portion detachably connected to the massage member,
wherein the connecting rod and the connecting member are threaded connected by rotating along the thread;
wherein the second portion extends into a recessed area defined by the arc-shaped concave surface and a circular base, which is formed by extending from the periphery of the arc-shaped concave surface to a connecting opening of the massage member abutting against the connecting portion, and a contacting surface of the second portion, which abuts against the arc-shaped concave surface, is configured to match the arc-shaped concave surface, and a center point of the arc-shaped concave surface is located outside the recessed area;
wherein the first portion and the second portion are arranged along the first direction, a part of the second portion extends along lateral directions relative to the first portion, the lateral directions are perpendicular to the first direction, the first portion having a first maximal cross-section which is perpendicular to the first direction, the second portion having a second maximal cross-section which is perpendicular to the first direction, wherein the first maximal cross-section is smaller than the second maximal cross-section;
a hardness of the connecting member is greater than a hardness of the massage member; and an engagement relationship between the connecting member and the massage member is established via the cooperation between the arc-shaped concave surface and the contacting surface of the second portion without additional engagement elements.

2. The fascia gun according to claim 1, wherein a maximum depth of the recessed area is shorter than a radius of the connecting opening.

3. The fascia gun according to claim 2, wherein a length from the center point to the connecting opening is longer than the maximum depth of the recessed area.

4. The fascia gun according to claim 1, wherein the second portion includes a sidewall surrounding the end of the first portion and an end wall inwardly extending from the sidewall and connected to the end of the first portion, wherein the sidewall is protruding relative to the end wall.

5. The fascia gun according to claim 4, wherein the circular base complete covers and/or aligns with the sidewall.

6. The fascia gun according to claim 1, wherein a diameter of the second portion at a second direction, is at least 1.3-1.5 times longer than a diameter of the first portion at the second direction, the second direction is perpendicular to the first direction.

7. The fascia gun according to claim 1, wherein a difference value between a diameter of the circular base and a maximal size of the second portion in a direction perpendicular to the first direction is 0.8 mm.

8. The fascia gun according to claim 1, wherein the connecting member has a massage surface which is selective to directly contact with the object to be massaged when the massage member is detached from the connecting member.

9. The fascia gun according to claim 1, wherein the massage member comprises a plurality of reinforcing ribs configured for preventing the massage member from deformation, the plurality of reinforcing ribs is arranged along a circumference of the recessed area, and each reinforcing rib extends radially.

10. The fascia gun according to claim 1, further comprising: a driving member received in the housing and configured for driving the massage head to move linearly, wherein the driving member includes a rotating shaft, an eccentric wheel coupled to the rotating shaft, the eccentric wheel having an eccentric rod offset from an axis of the rotating shaft, a bearing sleeved on the eccentric rod and the connecting rod with one end coupled to the bearing.

11. The fascia gun according to claim 10, wherein the fascia gun includes a positioning plate sleeved on the driving member, and four corners of the positioning plate contacts to the housing.

12. The fascia gun according to claim 10, wherein the driving member includes a limiting sleeve is clamped to an inner wall of the housing, and the connecting rod reciprocates relative to the limiting sleeve.

13. A fascia gun comprising:
a massage apparatus including an opening;
a driving member received in the massage apparatus, and a portion of the driving member extending out of the massage apparatus through the opening;
a massage member configured to contact an object to be massaged, the massage member comprising a massage contacting surface configured for contacting the object to be massaged, and an arc-shaped concave surface arranged opposite the massage contacting surface and curving inward toward the massage contacting surface; and
a connecting member configured to connect the massage member to the driving member of a massage apparatus, the connecting member reciprocally moving along a first direction and being driven by the driving member, wherein the connecting member comprises a first portion arranged along the first direction and a second portion extending toward a second direction intersecting with the first direction, and the first portion is coupled with the driving member of the massage apparatus,
wherein the connecting member is connected to the driving member by threads;
wherein the second portion extends into a recessed area defined by the arc-shaped concave surface and a circular base formed by extending from the periphery of the arc-shaped concave surface to a connecting opening of the massage member abutting against the connecting portion , a contacting surface of the second portion, which abuts against the arc-shaped concave surface, is configured to match the arc-shape concave surface and a depth of the recessed area is shorter than a radius of the circular base;
wherein, the second portion extends into the recessed area, and the massage member is detachably connected to the connecting member, an area of a second maximal cross-section of the second portion, at a plane that is perpendicular to the first direction, is larger than an area of a first maximal cross-section of the connecting member, at the plane is perpendicular to the first direction,
a hardness of the connecting member is greater than a hardness of the massage member; and an engagement relationship between the connecting member and the massage member is established via the cooperation between the arc-shaped concave surface and the contacting surface of the second portion without additional engagement elements.

14. The fascia gun according to claim 13, wherein the second portion includes a sidewall surrounding the end of the first portion and an end wall inwardly extending from the sidewall and connected to the end of the first portion, wherein the sidewall is protruding relative to the end wall.

15. The fascia gun according to claim 14, wherein the circular base complete covers and/or aligns with the sidewall.

16. The fascia gun according to claim 13, wherein a diameter of the second portion at a second direction, is at least 1.3-1.5 times longer than a diameter of the first portion at the second direction, the second direction is perpendicular to the first direction.

17. The fascia gun according to claim 13, wherein a cross-sections of the massage contacting surface, which are perpendicular to the first direction, gradually decreases or gradually increases along the first direction.

18. The fascia gun according to claim 13, wherein the recessed area is provided with a plurality of reinforcing ribs configured for preventing the massage member from deformation, the plurality of reinforcing ribs are arranged along a circumference of the recessed area, and each of the plurality of reinforcing ribs extends radially.

19. The fascia gun according to claim 13, wherein
a shape of the massage contacting surface is irregular.

20. A massage head comprising:
a massage member configured to contact an object to be massaged, the massage member comprising a massage contacting surface configured for contacting the object to be massaged, and an arc-shaped concave surface arranged opposite the massage contacting surface and curving inward toward the massage contacting surface; and
a connecting member configured to connect the massage member to a driving member of a massage apparatus, the connecting member reciprocally moving along a first direction and being driven by the driving member, wherein the connecting member comprises a first portion arranged along the first direction and a second portion extending toward a second direction intersecting with the first direction, and the first portion is coupled with the driving member of the massage apparatus,
wherein the connecting member is connected to the driving member by threads;
wherein the second portion extends into a recessed area defined by the arc-shaped concave surface and a circular base formed by extending from the periphery of the arc-shaped concave surface to a connecting opening of the massage member abutting against the connecting portion , a contacting surface of the second portion, which abuts against the arc-shaped concave surface, is configured to match the arc-shape concave surface and a depth of the recessed area is shorter than a radius of the circular base;
wherein, the second portion extends into the recessed area, and the massage member is detachably connected to the connecting member, an area of a second maximal cross-section of the second portion, at a plane that is perpendicular to the first direction, is larger than an area of a first maximal cross-section of the connecting member, at the plane is perpendicular to the first direction,
a hardness of the connecting member is greater than a hardness of the massage member; and an engagement relationship between the connecting member and the massage member is established via the cooperation between the arc-shaped concave surface and the contacting surface of the second portion without additional engagement elements.
